(19) United States
(12) Patent Application Publication
(10) Pub. No.: US 2006/0227946 A1
(43) Pub. Date: Oct. 12, 2006

(54) Voice activated printer

(75) Inventor: Kenneth C. Henderson, Penfield, NY (US)

Correspondence Address: PILLSBURY WINTHROP SHAW PITTMAN, LLP, P.O. BOX 10500, MCLEAN, VA, 22102, US

(73) Assignee: Xerox Corporation

(21) Appl. No.: 11/094,963

(22) Filed: Mar. 31, 2005

(51) Int. Cl. H04M 11/00

(52) U.S. Cl. 379/100.01; 379/102.01; 379/102.02

(57) ABSTRACT

An intelligent audio-activated document production device controlled through a telephony device.

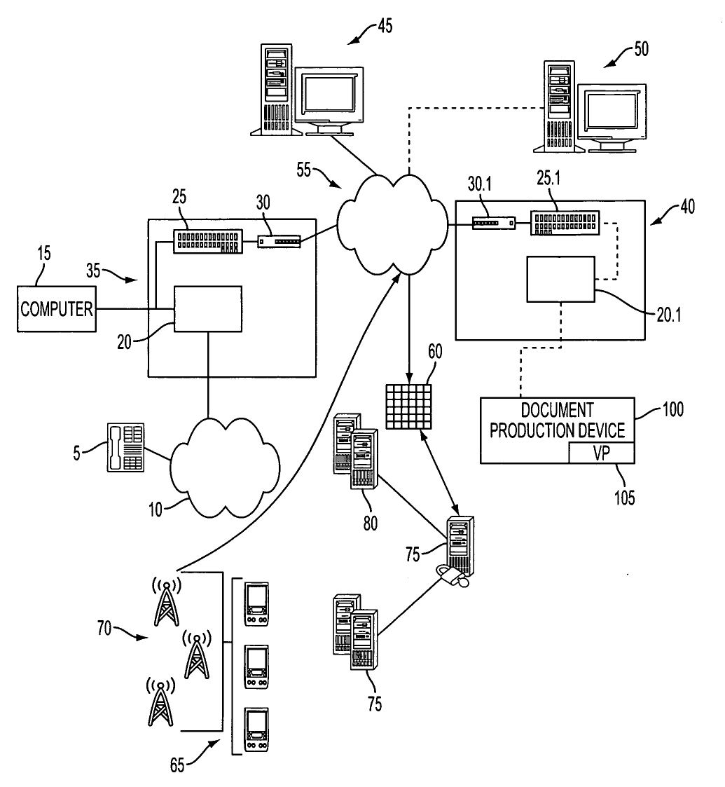

### BACKGROUND

All references cited in this specification, and their references, are incorporated by reference herein where appropriate for teachings of additional or alternative details, features, and/or technical background.

Disclosed in the embodiments herein is an intelligent sound-activated document production device, such as a printer or copier, in particular an intelligent audio-activated document production device.

In today's business environment, one may be faced with the need to print documents, or copies of a documents, from a remote location. Remote printing through printers and copiers from computer terminals found at different locations is known, and is employed regularly in many companies. Such remote printing involves initiation of a print job from a computing device which sends printer commands to the printer, production press or copier etc. Print commands with respect to a particular document are cued in line in the remote hardcopy image production device and the jobs are produced in the order of their receipt on demand. In respect of copy attributes (such as stapling of copies, use of colored paper or hole-punched paper, etc.), remote printing may offer significantly fewer options to a user of the hardcopy image production device than if the user was able to directly interface with the machine controls, due to more limited copy attribute functions associated with the software sending the print command to the hardcopy image production device.

A document, or copies of documents, may be needed at a time when direct access to a hardcopy image production device, such as a printer or copier, or remote computing device is not possible. Waiting until access to the front end of the hardcopy image production device becomes available is not infrequently a undesirable alternative. Remote printing through a computer requires that the computer be loaded with a copy of document which is desired to be printed as well as a program compatible with the hardcopy image production device.

A system that would permit remote printing from a location wherein computer access is not readily at hand would be desirable. A system that would permit delayed remote printing would also be desirable.

### REFERENCES

U.S. Pat. No. 4,375,329, commonly assigned, discloses talking copiers and duplicators. A speech module is connected to the master controller in a reproduction machine. Upon sensing certain machine conditions, the master controller provides suitable signals to the voice response module. In response, the voice response module locates starting addresses and lengths of words and phrases and reproduces the appropriate response.

U.S. Pat. No. 5,369,469, commonly assigned, related to a method of acquiring spontaneous unsolicited customer input, in particular from an electrophotographic printer customer. It discloses a method of receiving and processing verbal input form a user of a printing machine having at least a voice input activator, a voice receiver, an output signal connected to a communications medium, and an output receiving station remote from the machine.

U.S. Pat. No. 5,744,788 discloses a voice-activated optical scanning system. A hands-free scanning system for reading indicia having parts of different light reflectivity mounted to the arm of an operator initiates reading of the indicia upon audio command (i.e., voice activation) from a user.

U.S. Pat. No. 6,167,218 discloses image production equipment operable under voice direction. An operator depresses a voice registration key to set a voice registration mode, and registers the copy mode having been set at memory, and inputs the voice input for the copy mode registered through a microphone while depressing a voice input key, and registers the voice for the copy mode so that a desired copy mode can be called at any time.

U.S. Pat. No. 6,188,985 B1 discloses a wireless voice-activated device for control of a processor-based host system, such as a computer connected to the World Wide Web. The device disclosed has a display, microphone, and a wireless transmitter and receiver, and optionally a processor and memory for performing voice recognition. The device may be used for voice-controlled Web browsing.

U.S. Pat. No. 6,240,448 B1 discloses audio enabled pages that can be retrieved by an audio web server that interprets the pages into audio. In one embodiment the user uses the keypad of the phone or spoken commands to traverse the audio menus. Different kinds of information existing on the web are provided in a form suitable for access over a variety of audio interfaces which include touch tone and speech recognition.

U.S. Pat. No. 6,747,566 B2 discloses a voice-activated remote control unit for multiple electrical apparatuses, such as a TV set, a DVD player, a stereo system, an air conditioner. The remote control allows a user to remotely turn on/off and control the operations of the electrical apparatuses through voice-activation.

### SUMMARY

Aspects disclosed herein include:

an automated printing system operatively configured to print select documents in response to remote audio commands with respect to a select document to be printed, the number of copies of the document to be produced, and optionally with respect to the time when the copies are to be produced.

In another embodiment there is disclosed a system comprising a data storage device storing electronic versions of documents in association with a document identifier; a telephony device having an addressable receiver; an audio-processor operatively configured to process audio analog signals directed at said telephony device to audio digital signals; a remote document production device operatively associated with a one or more digital processor(s) operatively configured to process said audio digital signals from said audio-processor and to produce, in response to receipt of said audio digital signal, at least one audio menu comprising a number of audio options correlative with executable functionalities on said document production device, to transmit said audio menu to said addressable receiver of said telephony device along with an audio signal inquiry in regard to said identifier of the document desired to be produced by said document production device, and to process signals received in response to said audio menu and audio inquiry so as to produce documents requested in response to said audio inquiry in the manner of the responses to said audio menu.

In yet another embodiment, there is disclosed a method comprising converting an audio analog signal, including information pertaining to a particular document stored in one or more document data storage unit(s) that is desired to be printed, to an audio digital signal; transmitting the audio digital signal to a remote document production device operatively configured to print documents stored in said one or more document data storage unit(s) in response to audio digital signals; obtaining documents printed in response to said audio digital signals.

### BRIEF DESCRIPTION OF THE DRAWING

Various of the above mentioned and further features and advantages will be better understood from this description of embodiments thereof, including the attached drawing FIGURE wherein there is shown a schematic representation of a system for producing documents on a document production device by remote input, including input by a telephony device.

### DETAILED DESCRIPTION

In embodiments there is illustrated an automated printing system, such as a electrophotographic system including, but not limited to, a printer, copier, and offset press, operatively configured to print select documents in response to remote audio commands with respect to a select document to be printed, the number of copies of the document to be produced, and optionally with respect to the time when the copies are to be produced which time may be any time from receipt of the remote audio command. The remote audio commands may be sent by telephony device such as a telephone, a cell phone, or a wireless handheld email-telephony device, or combination thereof.

In today's business environment, one may find the need to print a document that is not locally available. While print-on-demand capabilities are provided on some document production devices, access to the device may be limited in particular when a remote computer is not readily available from which to print or significant connection times have to be incurred before accessing the document production device.

Personal Voice Assistant (“PVA”) is now being offered by Trinsic, formerly Z-tel, to allow persons to obtain information by means of telephony devices. PVA makes use of speech recognition software, Voice-XML technology, as well as text-to-speech engines to allow for easy storage of data as audio files and quick response to verbal questions (Voice Extendible Markup Language, “Voice-XML,” which brings speech, touch-tone input, digitized audio, recording and computer-human conversations to the Web from any telephone, and (speech recognition grammar are more fully explained at the World Wide Web, “W3C” consortium website). PVA technology may be stored in a central server and data stored in a data storage devices. For example, PVA can be used to enable dialing of a phone number by speaking the name of a contact in an online address book or by saying the digits of the telephone number, to set up distribution lists to send voice emails to several contacts at once, to access online address book contacts, and to share contacts with others.

It is recognized herein that the technology behind PVA can be used not only for retrieval of audio information from audio input, but also to control devices, such as a document production device. The control of a document production device from a remote telephony device through one or more audio menus permits one obtain documents when and where needed without the need to have an available networked computer at hand.

An intelligent voice-activated service, such as a PVA, can be used to control a document production device, such as a printer or production press. The audio commands, which may be a voice or sound, as for example a tone on the phone, which may be made accessible through audio menus, may allow a user to access files, select documents to print, or change portions of the document before printing. Through the menu, or direct audio command, the resultant job may be directed to a specific document production device, such as a printer. Optionally, authorized users may be determined by authentication through voice recognition software, inputting of an authorized password, or simply recognition of an identity code of the telephony device as an authorized identity code (for example, the telephone code). Authentication of the user can be used to permit access to certain document repositories operationally associated with the system, and optionally right to edit such documents through audio command. Further, the system may transcribe audio analog signals to text to allow creation of new print jobs. Content of a document may be changed using an intelligent audio-driven document interface. Users, by providing appropriate verbal input, can create document related transactions using such a system's distribution lists of individual recipients of a produced document, send print jobs to specific output devices on the entity's intranet or the internet, and print by name. Persons with little experience with the underlying PVA and document production device technology may interact with production processes to produce desired high-quality documents without prior knowledge of the full capabilities of the document production device. As telephony devices may be wireless, it permits freedom in printing and distributing documents. Telephony devices may make use of many technologies to transmit a signal including transmission by wire or cable, such as with a traditional telephone or voice over internet protocol (“VoIP”), and wirelessly such as by bluetooth.

In one embodiment, there is disclosed a system comprising a data storage device storing electronic versions of documents in association with a document identifier, a telephony device having an addressable receiver, an audio-processor operatively configured to process audio analog signals directed at said telephony device to audio digital signals, a remote document production device operatively associated with a one or more digital processor(s) operatively configured to process said audio digital signal and to produce at least one audio menu comprising a number of executable functionalities on said document production device in response to receipt of said audio digital signal, to transmit said audio menu to said addressable receiver of said telephony device along with an audio signal inquiry in regard to the identifier of the document desired produced by said document production device, and to process signals received in response to said audio menu and audio inquiry in a manner so as to transact upon responses to said audio menu and said audio inquiry to produce documents requested in response to said audio inquiry and in the manner of the responses to said audio menu.

The data storage device may be any type of data storage device, such as hard storage operatively connected with one or more processor(s), by which it is meant to include, without limitation, computers, remote to said remote document production device. The stored data may be queried via any mode of communication, including through a widely-distributed network such as the Internet.

By “telephony device” it is meant any electronic device which allows for communication of a sound from one widely removed location to another without requiring sound wave propagation along the path of communication and may or may not make use of wires. Telephony devices include, without limitation, a telephone, a cell phone, and combination products such as a wireless handheld email-telephony devices. The telephony device may include the audio-processor for converting a audio analog signal to an audio digital signal.

By “audio menu” it is meant to include an assortment of verbal option offerings.

By “remote document production device” it is meant to include, without limitation, a printer, a copier, a xerographic device, and an offset press, or combination thereof.

By “document” it is meant to include an image or set of images desired to be printed or otherwise displayed, or data relating thereto in any format.

The audio menu proffered the user by the system may comprise one or more options relating to the handling and production of the document(s) which are desired to be produced. For example, an option to control the number of prints made, an option to control the characteristics of the medium upon which the print is printed, an option to delay the time of printing with respect to the request for printing, and an option to place the documents in a secure bin until such documents are retrieved, or combination thereof, may all be provided. For example, the option to delay printing may be selected when the person requesting printing wishes to collect the documents at some point in time in the future and does not wish the documents to be available in the document production device for viewing by others. Similarly, the option to print to a secured bin may be selected when the user wishes to print soon, but to pick the documents up later without fear that someone without authorization may review the copies. The audio menu may comprise a layered audio menu wherein further menus are provided in regard to certain select responses. The audio menu may be provided, for example, by associating certain digital input with a menu selection, by employment of Voice XML pages etc.

A document that is desired to be produced, may be produced from electronic document files stored in data storage and may be associated with an identifier which may comprise the path on which a document may be found with respect to a particular computer or computer system. The identifier on the other hand can identify a particular document with the path supplied by the user of the system either through response to inquiries, input, or by associating the user with a particular document storage path including association by use of voice recognition technology. Thus, one could by audio seek to print seven copies of Document No. 11013456, and by recognition of the user employing the system through recognition, and knowledge of the path in which the user stores documents, permit the system to produce seven copies of this document. Access to produce such document may be limited to users who are determined to be authorized to produce the documents by use of voice recognition or by supplying a previously supplied password.

In a further embodiment, there is disclosed a method comprising converting an audio analog signal, including information pertaining to a particular document stored in one or more document data storage unit(s) that is desired to be printed, to an audio digital signal; transmitting the audio digital signal to a remote document production device operatively configured to print documents stored in said one or more document data storage unit(s) in response to audio digital signals; and obtaining documents printed in response to said audio digital signals.

Now turning to the FIGURE there is shown a schematic of an intelligent audio-activated document production device. Access of to the system is made by way of a telephony device, for example by telephone(s) 5 or hand-held email-telephony device(s) 65 through telecommunication pathways such as PSTN 10 or towers 70 tuned to receive wireless signals. Of course, access to the document production device may alternatively or concomitantly be made by input through processing device 15 or a network of processing devices 80, 85 connected, for example, through central server 75 and protected by firewall 60 either by non-verbal or verbal input (for example, using VoIP communication). Digital signals from PSTN 10 or computer 15 to document production device 100 and from document production device 100 to PSTN 10 and telephone 5 or computer 15 may pass to/from widely-distributed network system 55, such as the internet, through, for example, IT-gateway 20, 20.1 (by gateway it is meant to include a node on a network that serves as an entrance to another network), ethernet switch 25, 25.1 (by switch it is meant to include a device that filters and forwards packets between LAN segments), IP router 30, 30.1 (by router it is meant to include a device that forwards data packets along networks). Document production 100 may comprise voice or audio processor 105 to process the digital signals and to send responsive menus or inquiries thereto. Of course, voice or audio processor 105 may be located remotely from said document production device 100. Document production device 100 may obtain the document to be printed by formatting audio information into text or may obtain the document from a data storage device upon which the document is stored whether housed in proximity to document production device 100 or from one or more of data storage devices connectable to the system as, for example, processing devices 45 and 50 connected through wide-area network 55 based on audio input at the telephony device, which may be in response to the menus offered.

While the invention has been particularly shown and described with reference to particular embodiments, it will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An automated printing system operatively configured to print select documents in response to remote audio commands with respect to a select document to be printed, the number of copies of the document to be produced.

2. A system in accordance with claim 1 wherein the remote audio commands are sent by telephony device.

3. A system in accordance with claim 2 wherein the telephony device is a telephone, a cell phone, or a wireless handheld email-telephony device, or combination thereof.

4. A system in accordance with claim 1 wherein the automated printing system is a xerographic system.

5. A system in accordance with claim 1 wherein the automated printing system is a printer, a copier, or an offset press, or combination thereof.

6. A system in accordance with claim 1 wherein the automated printing system is responsive to remote audio commands in respect to the time when the copies are to be produced and the time when the copies are to be produced ranges from a time immediate to receipt of the remote audio command to any time subsequent receipt of the remote audio command.

7. A system comprising
a data storage device storing electronic versions of documents in association with a document identifier,
a telephony device having an addressable receiver,
an audio-processor operatively configured to process audio analog signals directed at said telephony device to audio digital signals,
a remote document production device operatively associated with a one or more digital processor(s) operatively configured to process said audio digital signals from said audio-processor and to produce, in response to receipt of said audio digital signal, at least one audio menu comprising a number of audio options correlative with executable functionalities on said document production device, to transmit said audio menu to said addressable receiver of said telephony device along with an audio signal inquiry in regard to said identifier of the document desired to be produced by said document production device, and to process signals received in response to said audio menu and audio inquiry so as to produce documents requested in response to said audio inquiry in the manner of the responses to said audio menu.

8. A system in accordance with claim 7 wherein the data storage device is hard storage operatively connected with one or more processor(s) remote to said remote document production device.

9. A system in accordance with claim 7 wherein the data storage device is accessible through a widely-distributed network.

10. A system in accordance with claim 9 wherein the widely-distributed network is the Internet.

11. A system in accordance with claim 7 wherein the telephony device is a telephone, a cell phone, or a wireless handheld email-telephony device, of combination thereof.

12. A system in accordance with claim 7 wherein the audio-processor is positioned in said telephony device.

13. A system in accordance with claim 7 wherein the audio-process or is positioned outside of said telephony device.

14. A system in accordance with claim 7 wherein the automated printing system is a xerographic system.

15. A system in accordance with claim 7 wherein the automated printing system is a printer, a copier, or an offset press, or combination thereof.

16. A system in accordance with claim 7 wherein the audio menu comprises one or more options selected from the group consisting of an option to control the number of prints made, an option to control the characteristics of the medium upon which the print is printed, an option to delay the time of printing with respect to the request for printing, and an option to place the documents in a secure bin until such documents are retrieved, or combination thereof.

17. A system in accordance with claim 7 wherein the document identifier comprises the path on which a document may be found with respect to a particular computer or computer system.

18. A method comprising
converting an audio analog signal, including information pertaining to a particular document stored in one or more document data storage unit(s) that is desired to be printed, to an audio digital signal;
transmitting the audio digital signal to a remote document production device operatively configured to print documents stored in said one or more document data storage unit(s) in response to audio digital signals;
obtaining documents printed in response to said audio digital signals.

19. A method in accordance with claim 18 wherein the remote document production device is a printer, a copier, an offset press, or combination thereof.

20. A method in accordance with claim 18 wherein the audio analog signal is converted to a digital data signal in a telephony device.
